(19) United States
(12) Patent Application Publication
(10) Pub. No.: US 2026/0186189 A1
(43) Pub. Date: Jul. 2, 2026

(54) BACKLIGHT PANEL

(71) Applicant: INDUSTRIAL TECHNOLOGY RESEARCH INSTITUTE, Hsinchu (TW)

(72) Inventors: Li-Ying WANG HE, New Taipei City (TW); Yi-Hao PENG, Taipei City (TW); Keng-Hsien LIN, Tainan City (TW)

(73) Assignee: INDUSTRIAL TECHNOLOGY RESEARCH INSTITUTE, Hsinchu (TW)

(21) Appl. No.: 19/005,640

(22) Filed: Dec. 30, 2024

(51) Int. Cl. F21V 8/00

(52) U.S. Cl. CPC G02B 6/0016; G02B 6/0036

(57) ABSTRACT

A backlight panel includes a substrate, a plurality of first structures, and a plurality of second structures. The plurality of first structures are disposed on one surface of the substrate, and the plurality of second structures are disposed on the same surface of the substrate and positioned between the plurality of first structures, wherein the plurality of second structures has a different profile from the plurality of first structures.

### CROSS-REFERENCE TO RELATED APPLICATIONS

### Background

### 1. Technical Field

This disclosure relates to a backlight panel.

### 2. Related Art

General backlight panels are often designed with specially shaped microstructures to enhance light emission brightness, by adjusting light output characteristics, to achieve higher brightness.

### SUMMARY

According to an embodiment of this disclosure, a backlight panel includes a substrate, a plurality of first structures and a plurality of second structures disposed on a surface of the substrate, wherein the plurality of second structures is between the plurality of first structures, and the plurality of second structures have a different profile from the plurality of first structures.

### BRIEF DESCRIPTION OF THE DRAWINGS

FIG. 1 is a schematic diagram illustrating structural arrangement of a backlight panel according to a first embodiment of the present disclosure.

FIG. 2 is a schematic diagram illustrating partial structures of the backlight panel according to the first embodiment of the present disclosure.

FIG. 3 is a schematic diagram illustrating structural arrangement of a backlight panel according to a second embodiment of the present disclosure.

FIG. 4 is a schematic diagram illustrating structural arrangement of a backlight panel structures according to a third embodiment of the present disclosure.

FIG. 5 is a schematic diagram illustrating structural arrangement of a backlight panel according to a fourth embodiment of the present disclosure.

FIG. 6 illustrates a cross-sectional schematic diagram of a first structure according to an embodiment of the present disclosure.

FIG. 7 illustrates a cross-sectional schematic diagram of a first structure according to another embodiment of the present disclosure.

FIG. 8 illustrates a cross-sectional schematic diagram of a second structure according to an embodiment of the present disclosure.

FIG. 9 illustrates a cross-sectional schematic diagram of a second structure according to another embodiment of the present disclosure.

### DETAILED DESCRIPTION

The present disclosure is described in detail in the following embodiments, with sufficient disclosure to enable any person skilled in the relevant art to understand the technical aspects of the disclosure and implement it accordingly. Based on the disclosed content of the specification, the claims, and the accompanying drawings, any person skilled in the relevant art may readily understand the objectives and advantages associated with the present disclosure. The following embodiments further elaborate on the aspects of the disclosure but do not limit the scope in any way.

The range described in the disclosure as “between the lower limit and the upper limit” includes both the “lower limit” and the “upper limit” themselves. For example, a range of angles between 35 degrees and 55 degrees is equivalent to a range of angles greater than or equal to 35 degrees and less than or equal to 55 degrees.

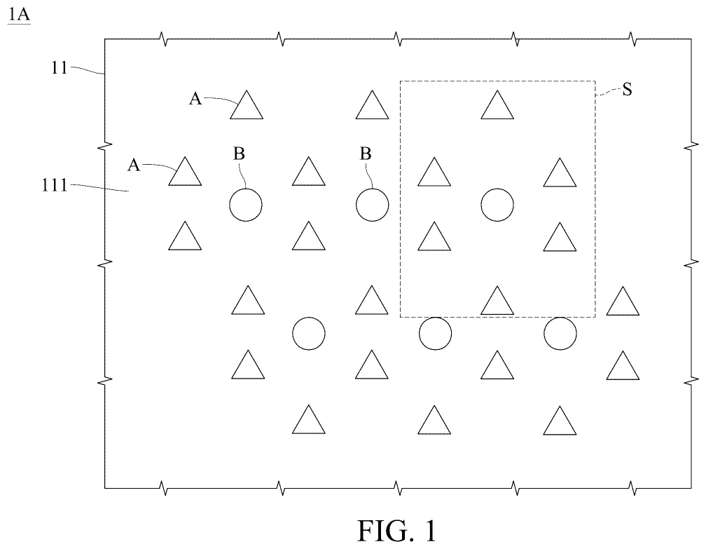

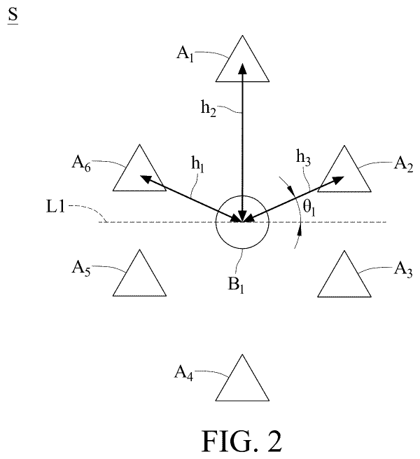

Please refer to FIGS. 1 and 2. FIG. 1 is a schematic diagram illustrating structural arrangement of a backlight panel according to a first embodiment of the present disclosure. FIG. 2 is a schematic diagram illustrating a partial structure of the backlight panel according to the first embodiment of the present disclosure. FIG. 2 may be regarded as a partial structure enclosed by the dotted line in FIG. 1. FIG. 1 illustrates a partial schematic view of the backlight panel, and the entire backlight panel may be composed of a plurality of arrangement shown in FIG. 1.

As shown in FIGS. 1 and 2, a backlight panel 1A includes a substrate 11, a plurality of first structures A and a plurality of second structures B. The plurality of first structures A and the plurality of second structures B are both disposed at the same surface 111 of the substrate 11, and the plurality of second structures B are located between the plurality of first structures A. The plurality of first structures A and the plurality of second structures B have different profiles. For example, the plurality of first structures A may be, but not limited to, ridge-shaped structures, and the plurality of second structures B may be, but not limited to, arc-shaped structures. For instance, an angle between a bottom surface and an inclined surface connected to the bottom surface of the first structure A may be between approximately 20 degrees and approximately 90 degrees. For instance, the second structure B may have a bottom surface and a curved surface connected to the bottom surface, wherein the curved surface may include an inner curved surface and/or an outer curved surface.

In the embodiment, one of the plurality of second structures B may be surrounded by an even number of first structures among the plurality of first structures A. For example, the arrangement of the plurality of first structures A and the plurality of second structures B may be as shown in FIG. 1, each of the second structures B may be surrounded by, but is not limited to, six first structures A. For example, as shown in FIG. 2, in the partial structure S, the plurality of first structures A₁ to A₆ surrounding the second structure B₁ may be mirror-arranged along a symmetry plane L₁ passing through the second structure B₁. The mirrored arrangement may be that arrangement positions of the first structures A₁, A₂, and A₆ are mirrored to arrangement positions of the first structures A₃, A₄, and A₅ along the symmetry plane L₁. The angle θ₁ between the symmetry plane L₁ and a connection line between the second structure B₁ and one of the plurality of first structures A₁˜A₆ (particularly the one adjacent to the symmetry plane L₁, such as the first structure A₂, A₃, As, and/or A₆) surrounding the second structure B₁ may be between about 35 degrees and about 55 degrees, and preferably around 45 degrees. In an embodiment, please refer to FIGS. 1 and 2, an angle between the symmetry plane L₁ and the connection line between the first structure A₁ and/or A₄ and one of other second structures B may be between about 35 degrees and about 55 degrees, and preferably around 45 degrees.

The plurality of first structures A₁˜A₆ comprises a first unit component and a second unit component, wherein a first distance between the first unit component and the second structure B₁ is shorter than a second distance between the second unit component and the second structure B₁. The first unit component may be the first structure A₂, A₃, As or A₆, while the second unit component may be the first structure A₁ or A₄. Taking the first structure A₆ as the first unit component and the first structure A₁ as the second unit component as an example, the distance h₁ between the first structure A₆ and the second structure B₁ may be smaller than the distance h₂ between the first structure A₁ and the second structure B₁. Taking the first structure A₂ as the first unit component and the first structure A₁ as the second unit component as an example, the distance h₃ between the first structure A₂ and the second structure B₁ may be shorter than the distance h₂ between the first structure A₁ and the second structure B₁. Specifically, the distance h₁ or h₃ (first distance) may be, for example, between about 20 micrometers and about 35 micrometers, and preferably may be, for example, 27.5 micrometers. The distance h₂ (second distance) may be, for example, between about 31 micrometers and about 46 micrometers, and preferably may be, for example, 38.5 micrometers.

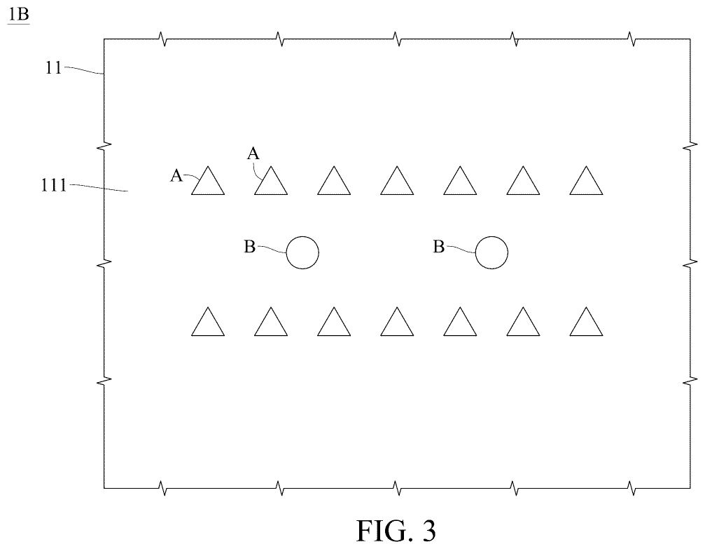

Please refer to FIG. 3, which is a schematic diagram illustrating structural arrangement of a backlight panel according to a second embodiment of the present disclosure. FIG. 3 illustrates a partial schematic view of the backlight panel, and the entire backlight panel may be composed of a plurality of arrangement shown in FIG. 3. As shown in FIG. 3, a backlight panel 1B comprises a substrate 11, a plurality of first structures A, and a plurality of second structures B. The plurality of first structures A and the plurality of second structures B are both disposed at the same surface 111 of the substrate 11, and the plurality of second structures B are located between the plurality of first structures A. The plurality of first structures A and the plurality of second structures B have different profiles. For example, the plurality of first structures A may be, but are not limited to, ridge-shaped structures, and the plurality of second structures B may be, but are not limited to, arc-shaped structures. The plurality of first structures A may be arranged in at least two columns, and the plurality of second structures B are located between the at least two columns of the first structures A. A structure quantity ratio of the plurality of first structures A to the plurality of second structures B may be between 6:1 and 10:1, to achieve good balance. The arrangement shown in FIG. 3 may include a periodic arrangement. For the periodic arrangement, the structure quantity ratio of the plurality of first structures A to the plurality of second structures B, for example, is 7:1, which may have good optical performance, with light uniformity of 93% and brightness of 2913 nits.

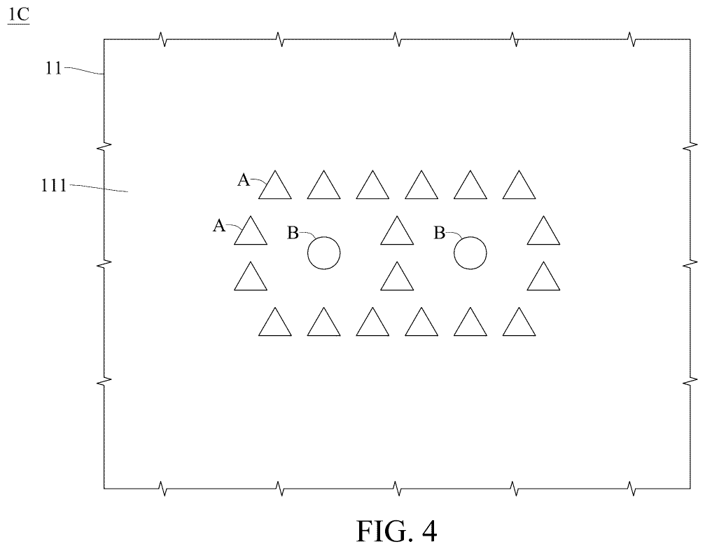

Please refer to FIG. 4, which is a schematic diagram illustrating structural arrangement of a backlight panel according to a third embodiment of the present disclosure. FIG. 4 illustrates a partial schematic view of the backlight panel, and the entire backlight panel may be composed of a plurality of arrangement shown in FIG. 4. As shown in FIG. 4, a backlight panel 1C comprises a substrate 11, a plurality of first structures A, and a plurality of second structures B. The plurality of first structures A and the plurality of second structures B are both disposed at the same surface 111 of the substrate 11, and the plurality of second structures B are located between the plurality of first structures A. The plurality of first structures A and the plurality of second structures B have different profiles. For example, the plurality of first structures A may be, but are not limited to, ridge-shaped structures, and the plurality of second structures B may be, but are not limited to, arc-shaped structures. A structure quantity ratio of the plurality of first structures A to the plurality of second structures B may be between 6:1 and 10:1, to achieve good balance. The arrangement shown in FIG. 4 may include the first structures A in periodic arrangement paired with the second structures B in special arrangement. For the special arrangement, the structure quantity ratio of the plurality of first structures A to the plurality of second structures B, for example, is 9:1, which may have good optical performance, with light uniformity of 90% and brightness of 2944 nits.

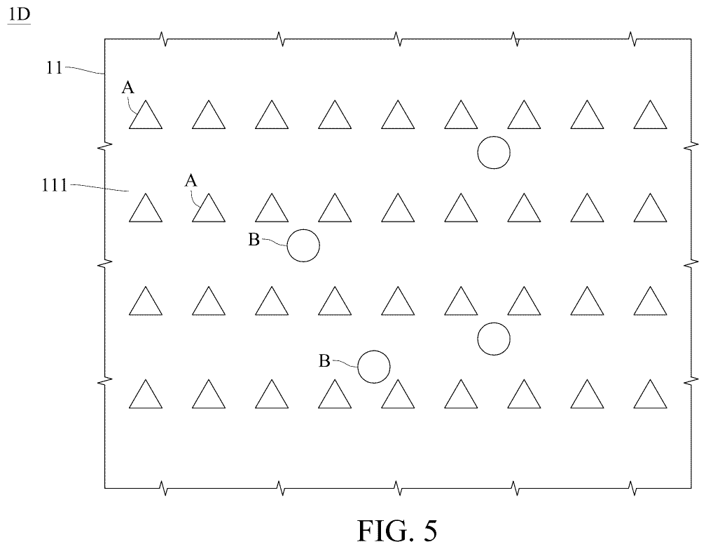

Please refer to FIG. 5, which is a schematic diagram illustrating structural arrangement of a backlight panel according to a fourth embodiment of the present disclosure. FIG. 5 illustrates a partial schematic view of the backlight panel, and the entire backlight panel may be composed of a plurality of arrangement shown in FIG. 5. As shown in FIG. 5, a backlight panel 1D comprises a substrate 11, a plurality of first structures A, and a plurality of second structures B. The plurality of first structures A and the plurality of second structures B are both disposed at the same surface 111 of the substrate 11, and the plurality of second structures B are located between the plurality of first structures A. The plurality of first structures A and the plurality of second structures B have different profiles. For example, the plurality of first structures A may be, but are not limited to, ridge-shaped structures, and the plurality of second structures B may be, but are not limited to, arc-shaped structures. The arrangement shown in FIG. 5 is the first structures A in periodic arrangement paired with the second structures B in irregular arrangement. For the irregular arrangement, the structure quantity ratio of the plurality of first structures A to the plurality of second structures B, for example, is 9:1, which may have good optical performance, with light uniformity of 92% and brightness of 2933 nits.

In an embodiment, the structure quantity ratio described above may refer to the quantity ratio of all first structures A to all second structures B contained in the entire backlight panel. In another embodiment, the structure quantity ratio may refer to the quantity ratio of the first structures A to the second structures B within a unit area, wherein the unit area may be defined based on the horizontal distance and vertical distance between the plurality of first structures A with each other. For example, the distance between two adjacent first structures A in the same horizontal direction may be defined as the horizontal pitch (x_pitch), and the distance between two adjacent first structures A in the same vertical direction may be defined as the vertical pitch (y_pitch). The unit area may then be calculated using Formula (1), wherein N is an integer greater than zero.

$$( x\_pitch * y\_pitch ) * N \qquad Formula ( 1 )$$

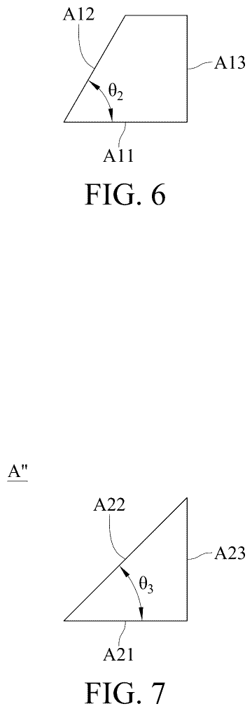

Please refer to FIG. 6, which illustrates a cross-sectional schematic diagram of a first structure according to an embodiment of the present disclosure. As shown in FIG. 6, the first structure A′ may be a ridge-shaped structure, and cross-section of which may be, for example, a trapezoid. The first structure A′ may include a bottom surface A11, an inclined surface A12 and a straight surface A13. The angle θ₂ between the bottom surface A11 and the inclined surface A12 connected to the bottom surface A11 of the first structure A′ may be between about 20 degrees and about 90 degrees. The inclined surface A12 may serve as a light-reflective surface. In other embodiments, the straight surface A13 of the first structure A′ may be replaced with an inclined surface, an inner curved surface or an outer curved surface.

Please refer to FIG. 7, which illustrates a cross-sectional schematic diagram of a first structure according to another embodiment of the present disclosure. As shown in FIG. 7, the first structure A″ may be a ridge-shaped structure, and cross-section of which may be, for example, a triangle. The first structure A″ may include a bottom surface A21, an inclined surface A22 and a straight surface A23. The angle θ₃ between the bottom surface A21 and the inclined surface A22 connected to the bottom surface A21 of the first structure A″ may be between about 20 degrees and about 90 degrees. The inclined surface A22 may serve as a light-reflective surface. In other embodiments, the straight surface A23 of the first structure A″ may also be an inclined surface, such as one that is equal to and symmetric with the inclined surface A22. That is, the angle between the bottom surface A21 and the two inclined surfaces connected to the bottom surface A21 may be 45 degrees. In other embodiments, the straight surface A23 of the first structure A″ of the first structure A″ may be replaced with an inclined surface, an inner curved surface or an outer curved surface.

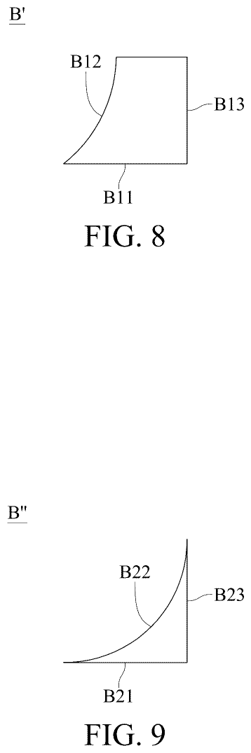

Please refer to FIG. 8, which illustrates a cross-sectional schematic diagram of a second structure according to an embodiment of the present disclosure. As shown in FIG. 8, the second structure B′ includes a bottom surface B11, a curved surface B12 and a straight surface B13. The bottom surface B11 is connected to the curved surface B12 and the straight surface B13. In FIG. 8, the curved surface B12 is illustratively shown as an inner curved surface, but the curved surface B12 may also be an outer curved surface, the disclosure is not limited to this. In other embodiments, the straight surface B13 of the second structure B′ may be replaced with an inner curved surface or an outer curved surface.

Please refer to FIG. 9, which illustrates a cross-sectional schematic diagram of a second structure according to another embodiment of the present disclosure. As shown in FIG. 9, the second structure B″ includes a bottom surface B21, a curved surface B22 and a straight surface B23. The bottom surface B21 is connected to the curved surface B22 and the straight surface B23. In FIG. 9, the curved surface B22 is illustratively shown as an inner curved surface, but the curved surface B22 may also be an outer curved surface, the disclosure is not limited to this. In other embodiments, the straight surface B23 of the second structure B″ may also be a curved surface, such as one that is equal to and symmetric with the curved surface B22. In other embodiments, the straight surface B23 of the second structure B″ may be replaced with an inner curved surface or an outer curved surface.

In view of the above description, the backlight panel disclosed in the embodiments of the present disclosure may have a plurality of different structures on the same surface of a single substrate to implement the enhancement of uniformity of light output from the backlight panel. Additionally, through the arrangement and structure quantity ratio of the plurality of different structures, the backlight panel disclosed in the embodiments of the present disclosure may have good optical performance and brightness uniformity.

1. A backlight panel, comprising:
a substrate;
a plurality of first structures disposed on a surface of the substrate; and
a plurality of second structures disposed on the surface of the substrate, and between the plurality of first structures, wherein the plurality of second structures have a different profile from the plurality of first structures,
wherein the plurality of first structures and the plurality of second structures are protruding structures.

2. The backlight panel according to claim 1, wherein one of the plurality of second structures is surrounded by an even number of the plurality of first structures.

3. The backlight panel according to claim 2, wherein the plurality of first structures surrounding the one of the plurality of second structures are mirror-arranged along a symmetry plane, and the symmetry plane passes through the one of the plurality of second structures.

4. The backlight panel according to claim 3, wherein an angle between the symmetry plane and a connection line between the one of the plurality of second structures and one of the plurality of first structures surrounding the one of the plurality of second structures is between 35 degrees and 55 degrees.

5. The backlight panel according to claim 2, wherein the plurality of first structures surrounding the one of the plurality of second structures comprises a first unit component and a second unit component, wherein a first distance between the first unit component and the one of the plurality of second structures is shorter than a second distance between the second unit component and the one of the plurality of second structures.

6. The backlight panel according to claim 5, wherein the first distance is between 20 micrometers and 35 micrometers.

7. The backlight panel according to claim 5, wherein the second distance is between 31 micrometers and 46 micrometers.

8. The backlight panel according to claim 1, wherein the plurality of first structures are arranged in at least two columns, and the plurality of second structures are located between the at least two columns.

9. The backlight panel according to claim 1, wherein a structure quantity ratio of the plurality of first structures to the plurality of second structures is between 6:1 and 10:1.

10. The backlight panel according to claim 1, wherein an angle between a bottom surface and an inclined surface connected to the bottom surface of one of the plurality of first structures is between 20 degrees and 90 degrees.

11. The backlight panel according to claim 10, wherein the plurality of first structures are a ridge-shaped structure.

12. The backlight panel according to claim 1, wherein one of the plurality of second structures has a bottom surface and a curved surface connected to the bottom surface.

13. The backlight panel according to claim 12, wherein the plurality of second structures are an arc-shaped structure.
